(19) United States
(12) Patent Application Publication
(10) Pub. No.: US 2012/0279538 A1
(43) Pub. Date: Nov. 8, 2012

(54) Doorstop Bar

(75) Inventor: Pao-Lu Chen, Taichung City (TW)

(73) Assignee: Ching's Shen Enterprise Corp., Taichung City (TW)

(21) Appl. No.: 13/102,772

(22) Filed: May 6, 2011

(51) Int. Cl. E05C 19/18; A45B 3/00

(52) U.S. Cl. 135/66; 292/289

(57) ABSTRACT

A doorstop bar includes a retractable bar, a stopping element, and an urging element. The retractable bar is retractable to adjust the length thereof. The stopping element is provided at the top of the retractable. The stopping element has a holding part, and a hooking element so as to be hung on the doorknob of a door. The doorstop bar can function as a walking stick as well.

### BACKGROUND OF THE INVENTION

1. Field of Invention

The invention relates to a doorstop bar and, in particular, to a device that urges against a door.

2. Related Art

FIG. 17 shows a conventional doorstop bar. Its top end is a stopping element 81 whose opening 811 has a U, V or some other shape. When in use, the opening 811 of the stopping element 81 is aligned with and urged against the bottom of the doorknob or the similar (not shown). One further adjusts the length of the retractable bar 82 of the doorstop bar according to needs, and puts the urging element 83 at the bottom end thereof in place. This can enhance the anti-theft effect. When not in use, the retractable bar 82 is retracted for storage.

Generally speaking, one usually stores the doorstop bar next to or near the door. Usually, it is stored vertically in order to save space. However, when somebody walks by or children play around it, the doorstop bar is likely to be kicked and fall, becoming an obstacle for walking. Suppose the doorstop bar is disposed horizontally at some corner in home. It may occupy too much space and have conflict with other furniture. So it is very inconvenient. Moreover, to avoid the above-mentioned problems, some people store the doorstop bar in a storage room. If other family members do not notice it and pile things thereon, it will become difficult or troublesome later on when the doorstop bar is needed. This will result in another problem.

Therefore, the doorstop bar in the prior art needs to be improved. In addition to stopping a door from being opened, the conventional doorstop bar has never been designed to have other functions. The doorstop bar of the invention can function as a walking stick as well.

### SUMMARY OF THE INVENTION

An objective of the invention is to provide a doorstop bar, which has a hook or a loop on the stopping element at the top end thereof To store the doorstop bar, one simply hangs it on the doorknob by the hook or loop. The doorstop bar thus hangs vertically in the air and close to the door, achieving the goal of better storage.

Another objective of the invention is to provide a doorstop bar, which has a sucking element on the urging element at the bottom end thereof The sucking element can suck onto the door made of an appropriate material. Using this mechanism, the doorstop bar vertically hanging by the door does not swing randomly and hit the person who opens the door. This achieves the goal of better storage.

A third objective of the invention is to provide a doorstop bar whose stopping element is designed to have a handheld structure. The doorstop bar can thus serve as a walking stick, providing an extra function for the doorstop bar.

Yet another objective of the invention is to provide a doorstop bar, the outer bar of whose retractable bar has at least two sections for the convenience of carriage and storage.

To achieve the above-mentioned objectives of simply a doorstop bar, the invention includes: a retractable bar, a stopping element, and an urging element. The retractable bar consists of an outer bar and an inner bar inserted into the outer bar from one end. The inner bar can extends out and retract into the outer bar. A positioning element is disposed between the inner bar and the outer bar for fixing the inner bar. The stopping element is provided at the top of the retractable bar. The stopping element has a holding part. Moreover, a hook is installed on the stopping element. The urging element is provided at the bottom of the retractable bar to urge against the ground.

The doorstop bar with the additional function of walking stick includes: a retractable bar, a stopping element, and an urging element. The retractable bar consists of an outer bar and an inner bar inserted into the outer bar from one end. The stopping element has a front fork part on the exposed end of the inner bar. The front end of the front fork part has a holding part. The top end of the front fork part is extended with at least one extension part from the side of the holding part. The extension part is bent to form the stopping part for holding when the invention is used as a walking stick. The extension direction of the stopping part is slightly perpendicular to the retractable bar. The stopping part, the extension parts, and the fork part form a space for the insertion of the neck part of the doorknob. The holding part is for the neck part to be embedded therein. The extension parts and the stopping part form a recess part for hooking the neck part at the bending portion. The urging element is pivotally provided at the bottom of the outer bar to urge against the ground. The urging element can be fixed after being adjusted to have an appropriate angle with respect to the ground.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a locally exploded three-dimensional view of a first embodiment of the invention;

FIG. 2 is an assembly view of FIG. 1;

FIG. 3 is a schematic view of using a positioning element to position the inner bar and the outer bar of the first embodiment;

FIG. 4 is a schematic view of using the doorstop bar to urge the door according to the first embodiment;

FIG. 5 is a schematic view of hanging the doorstop bar for storage according to the first embodiment;

FIG. 6 is a schematic view showing that the sucking element in FIG. 5 sucks onto a door;

FIG. 7 is a locally exploded three-dimensional view of a second embodiment of the invention;

FIG. 8 is an assembly view of FIG. 7;

FIG. 9 is a disassembled view of the doorstop bar according to a third embodiment;

FIG. 10 is a schematic view of using the doorstop bar of the third embodiment to stop a door;

FIG. 11 shows that the urging element of the third embodiment is pivotally connected to the end of the outer bar and that the outer bar swings sideways;

FIG. 12 shows that the urging element of the third embodiment is pivotally connected to the end of the outer bar and that the outer bar stands vertically;

FIG. 13 is a schematic view of hanging the doorstop bar on the neck part of the doorknob according to the third embodiment;

FIG. 14 is a schematic view of using the doorstop bar of the third embodiment as a walking stick;

FIG. 15 is a schematic view of the doorstop bar stopping a door according to a fourth embodiment;

FIG. 16 is a schematic view of using the doorstop bar of the fourth embodiment as a walking stick; and

FIG. 17 is a schematic view a conventional doorstop bar.

### DETAILED DESCRIPTION OF THE INVENTION

The present invention will be apparent from the following detailed description, which proceeds with reference to the accompanying drawings, wherein the same references relate to the same elements.

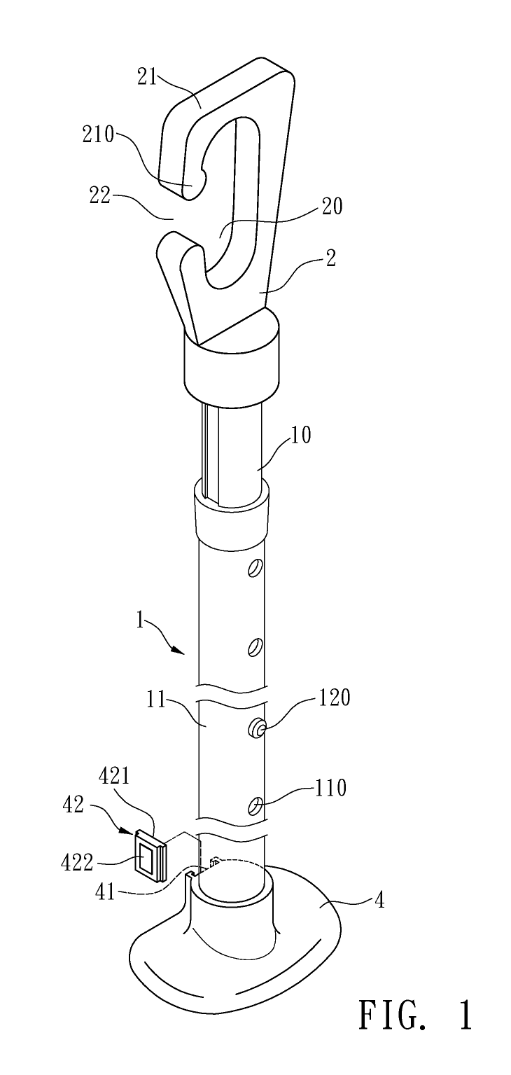

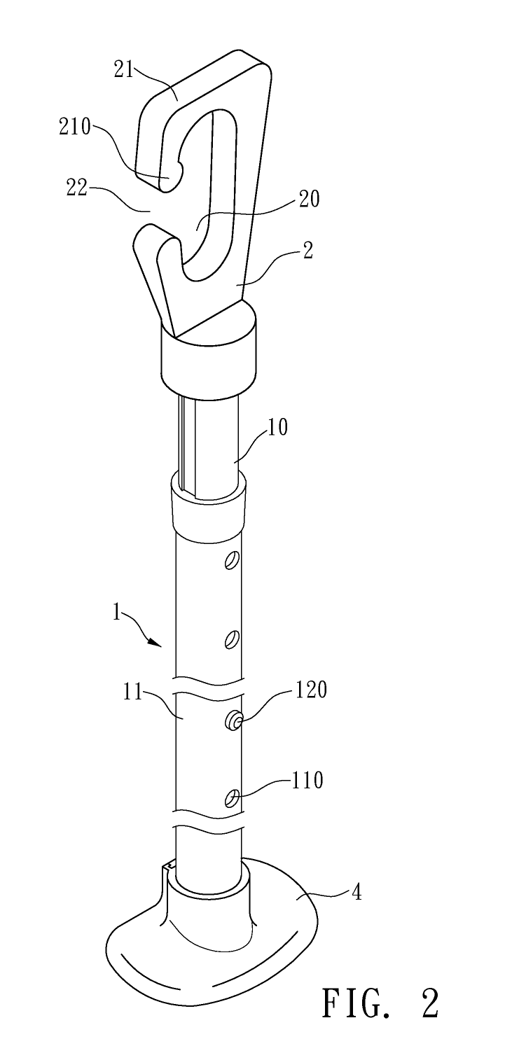

Please refer to FIGS. 1 to 2 for a first embodiment of the invention. The disclosed doorstop bar according to the embodiment includes: a retractable bar 1, a stopping element 2, and an urging element 4.

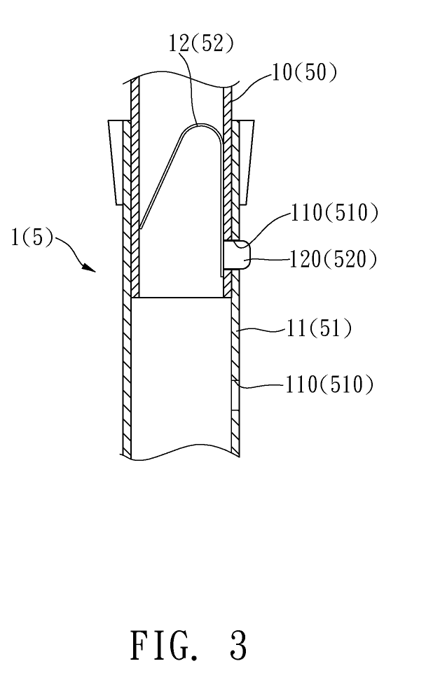

The retractable bar 1 consists of an inner bar 10 and an outer bar 11, with the inner bar 10 inserted from one end into the outer bar 11. The inner bar 10 can extend out of or retract into the outer bar 11. A positioning element is provided between the inner bar 10 and the outer bar 11 to fix the inner bar after being retracted. As shown in FIG. 3, the positioning element in this embodiment is a bent elastic chip 12 in the inner bar 10. A protruding button 120 that can restore the position thereof after being depressed is exposed from one side of the inner bar 10. The outer bar 11 along the retracting direction of the inner bar 10 has a plurality of positioning holes 110 in a line. Each positioning hole 110 allows the protruding button 120 to go out and stop when the inner bar 10 retracts.

The stopping element 2 is provided at the top of the inner bar 10 of the retractable bar 1. The stopping element 2 has a holding part 20 (in a U shape in this embodiment, V shape or the similar in other embodiments). The stopping element 2 has a hooking element, which in this embodiment is a hook 21 integrally formed with the stopping element 2. The hook 21 extends vertically upward from one side of the holding part 20 of the stopping element 2 and bends to form a hooking part 210. The bottom of the hooking part 210 and the other side of the holding part 20 of the stopping element 2 form a mount opening 22. The mount opening 22 enables one to mount the doorstop bar onto the neck part 30 of a doorknob 3.

The urging element 4 is provided at the bottom of the retractable bar 1. The back side of the urging element 4 is formed with an embedding recess 41. The embedding recess 41 has a sucking element 42 for a door. The sucking element 42 includes a first embedding part 421 and a magnet 422. The magnet 422 is installed on one side of the first embedding part 421. The other side of the first embedding part 421 is embedded in the embedding recess 41.

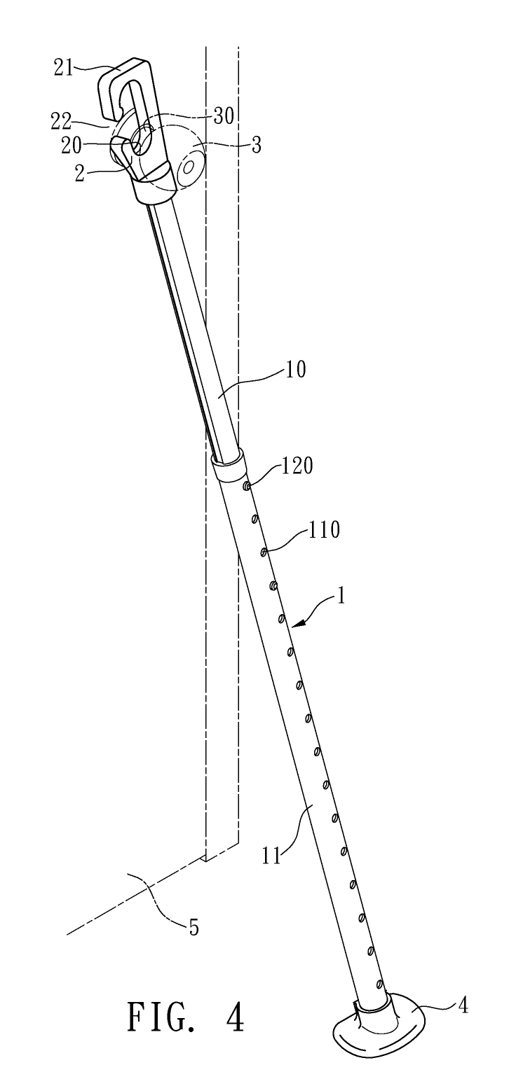

Please refer to FIGS. 1 and 4. When in use, the user presses the protruding button 120 so that the protruding button 120 disengages a positioning hole 110 of the outer bar 11. In this case, one can adjust the position of the inner bar 10 relative to the outer bar 11 and thus the length of the retractable bar 1. After mounting the stopping element 2 via the mount opening 22, the holding part 20 is aligned to a place underneath the neck part 30 of the doorknob 3 for urging. The urging element 4 is firmly against the ground. This then achieves the anti-theft effect by stopping the door 52.

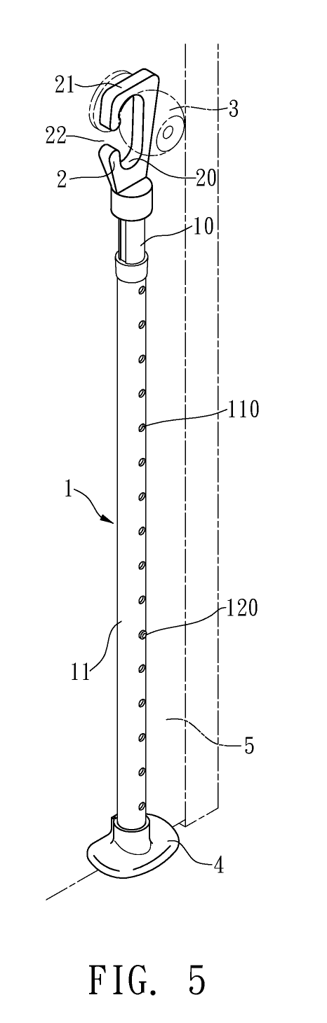

Please refer to FIGS. 1 and 5. To store the doorstop bar, the user presses the protruding button 120 in order to shorten the length of the retractable bar 1. The bottom edge of the hook 21 urges against the place above the neck part 30 of the doorknob 3 via the mount opening 22. In this case, the doorstop bar hangs vertically on the doorknob 3. This obviously solves the problems related to storage in the prior art.

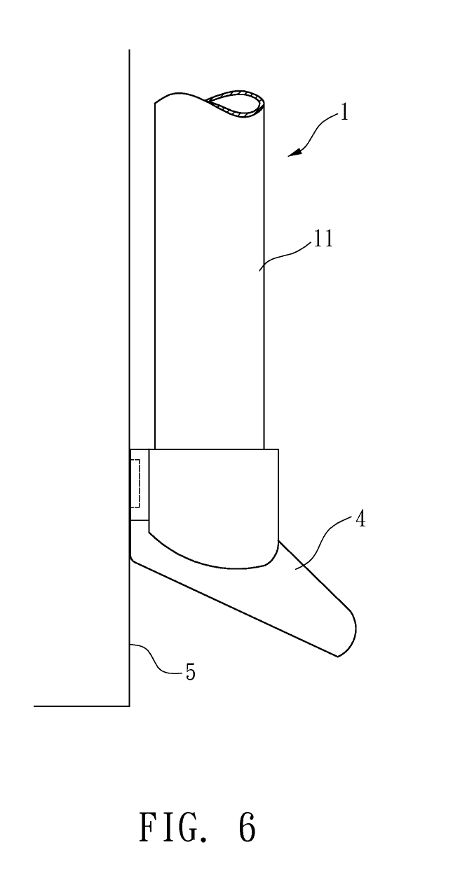

As shown in FIG. 6, using the sucking element 42 on the back side of the urging element 4, one can position the doorstop bar. For example, the sucking element 42 is a magnet 422 when the door is made of a magnetic metal (e.g. iron). Then the doorstop bar is magnetically attracted and fixed to the door. The hanging doorstop bar thus does not swing as one opens the door to hit the user.

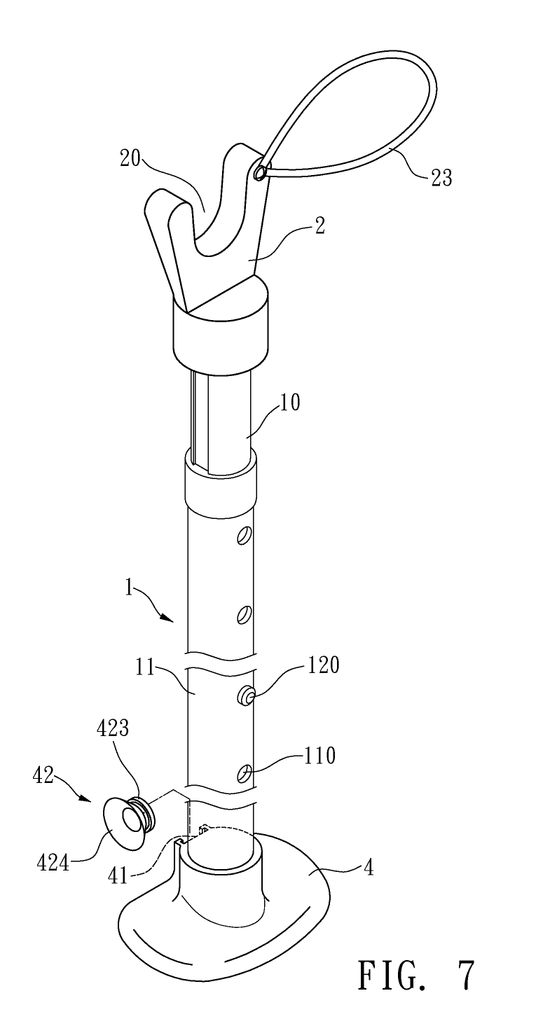

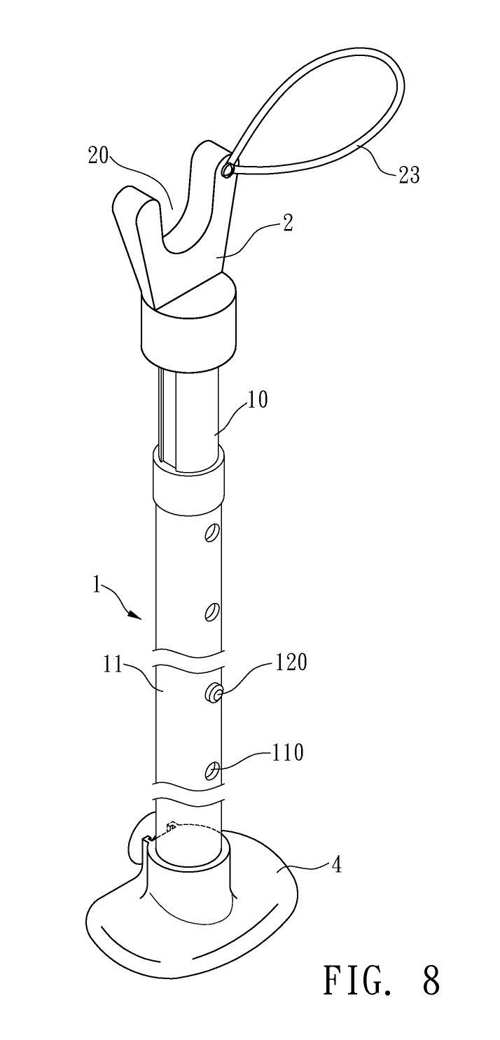

Of course, the invention has many other embodiments that differ from the previous one in details. Please refer to FIGS. 7 and 8 for a second embodiment of the invention. The hooking element on the stopping element 2 is implemented by a rope loop 23. The rope loop 23 can be directly mounted on the doorknob or the similar for the convenience of storage.

Besides, the sucking element 42 includes a second embedding part 423 and a sucker 424. The sucker 424 is provided on one side of the second embedding part 423. The other side of the second embedding part is embedded in the embedding recess 41.

The usage and advantages of the second embodiment are the same as the first embodiment, and are not repeated herein.

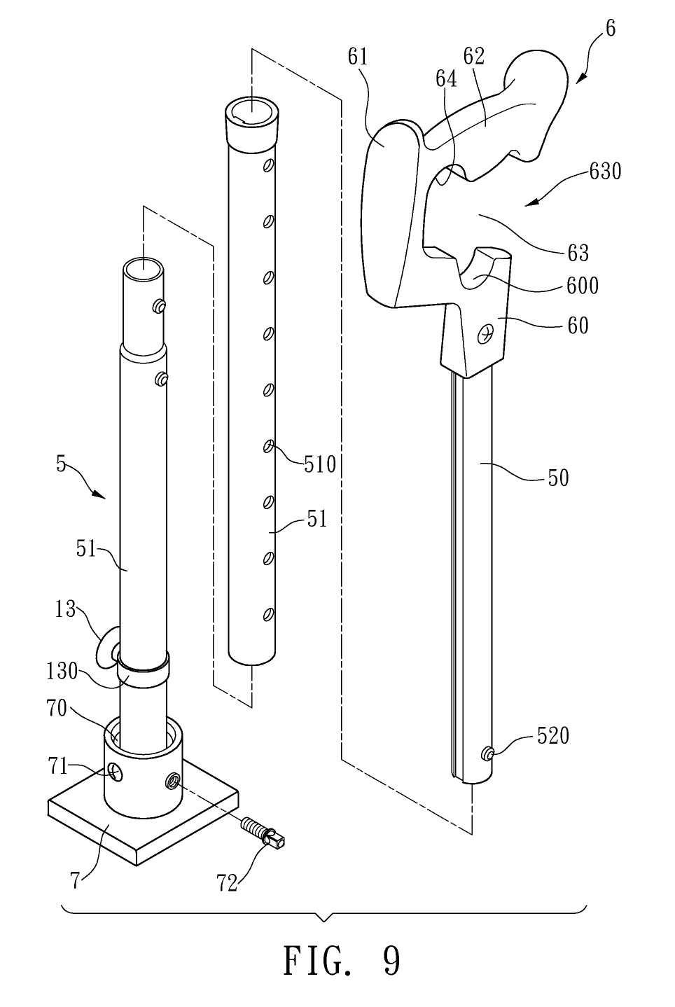

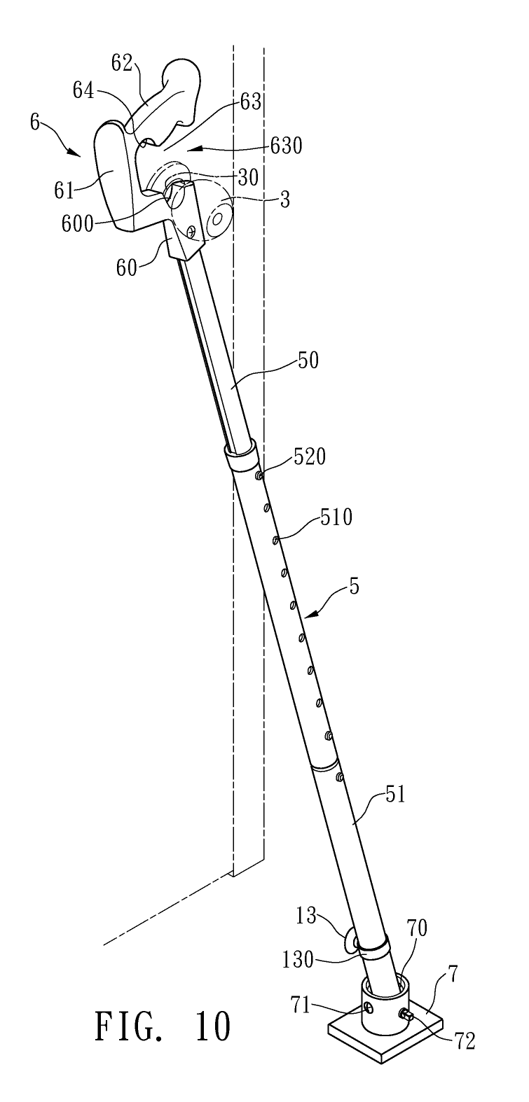

As shown in FIGS. 9 and 10, the retractable bar 5 includes an inner bar 50 inserted from one end into an outer bar 51. The inner bar 50 can extend out of or retract into the outer bar 51. A positioning element for fixing the retracted inner bar 50 is provided between the inner bar 50 and the outer bar 51. In this embodiment, the outer bar 51 has two sections that connect with each other when in use. Also as shown in FIG. 3, the positioning element is a bent elastic chip 52 in the inner bar 50. A protruding button 520 exposes from one side of the inner bar 50. The protruding button bounces back after being pressed. The outer bar 51 has a plurality of positioning holes 510 along the retracting direction of the inner bar 50 in a line. Each positioning hole 510 allows the protruding button 520 to go out and stop when the inner bar 50 retracts, thereby fixing the length of the retractable bar 5.

As shown in FIGS. 9 and 10, the stopping element 6 has a front fork part 60 extended from the exposed end of the inner bar 50. The front end of the front fork part 60 has a holding part 600. The top end of the front fork part 60 extends an extension part 61 toward the side of the holding part 600. The extension part 61 is bent to form a stopping part 62. The stopping part 62 can be held when the doorstop bar is used as a walking stick. The extension direction of the stopping part 62 is roughly perpendicular to the retractable bar 5. A space 63 is formed among the stopping part 62, the extension part 61, and the front fork part 60. The other side of the space 63 toward the extension part 61 has a mount opening 630 for the insertion of the neck part 30 of the doorknob 30. The holding part 600 allows the embedding of the neck part 30. The extension part 61 and the stopping part 62 form a recess part 64 at the bending portion in the space 63. The recess part 64 is then hooked on the neck part 30. In this embodiment, the width of the end of the front fork part 60 near the space 63 is shrunk inward, so that the doorknob is not blocked by the front fork part 60. The neck part 30 is then moved into the space 63 via the mount opening 630.

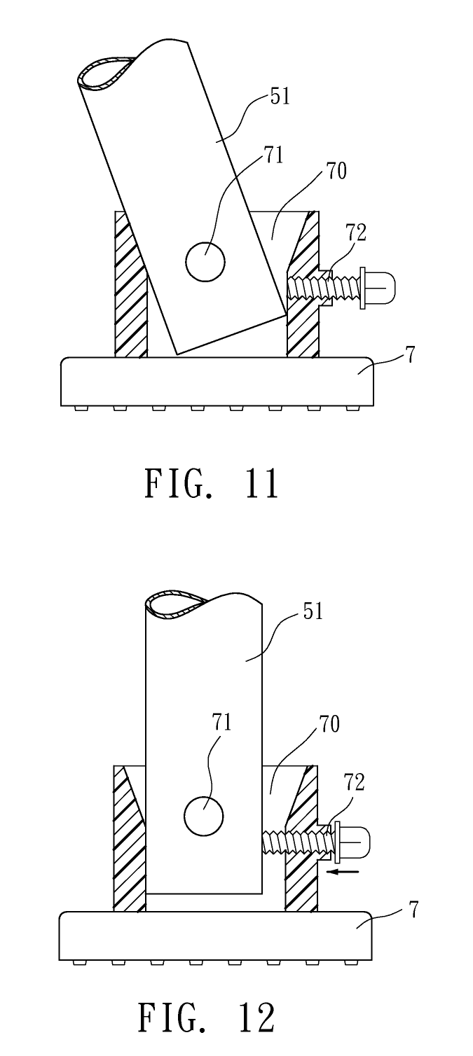

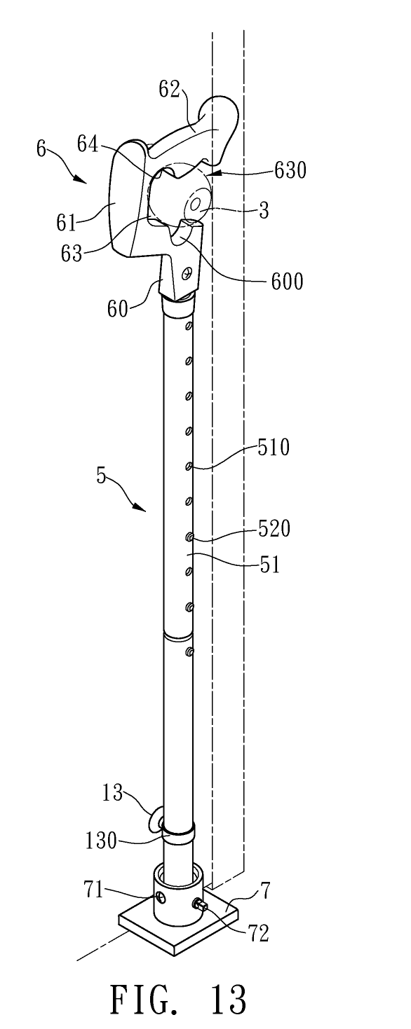

As shown in FIGS. 9 and 10, the urging element 7 is pivotally installed at the bottom of the outer bar 51 to urge against the ground. As shown in FIGS. 11 and 12, the urging element 7 is fixed after the angle between the outer bar 51 and the ground is adjusted. The urging element 7 has a cavity 70 for the insertion of one end of the outer bar 51. The width of the cavity 70 is greater than the diameter of the outer bar 51. A pivotal axis 71 goes through the urging element 7 and the outer bar 51. When the doorstop bar blocks the door, the outer bar 51 pivotally move sideways in the cavity 70, as shown in FIG. 11. The urging element 7 is locked inside the cavity 70 by a limiting screw 72 from the side. The limiting screw 72 can change the locking depth in the cavity 70. When the outer bar 51 stands vertically, the limiting screw 72 urges against the outer bar. As shown in FIG. 12, the outer bar 51 is limited to stand vertically when the doorstop bar is used as a walking stick.

Besides, this embodiment further includes a sucker 53 with a mounting ring 530 on the side. The mounting ring 530 mounts on the outer bar 51 so that the sucker is in the vicinity of one end of the urging element 7. One can move the sucker 53 to adjust the position thereof on the outer bar. Using this mechanism, the sucker 53 makes the end of the outer bar 51 near the urging element 7 stick to the door during storage.

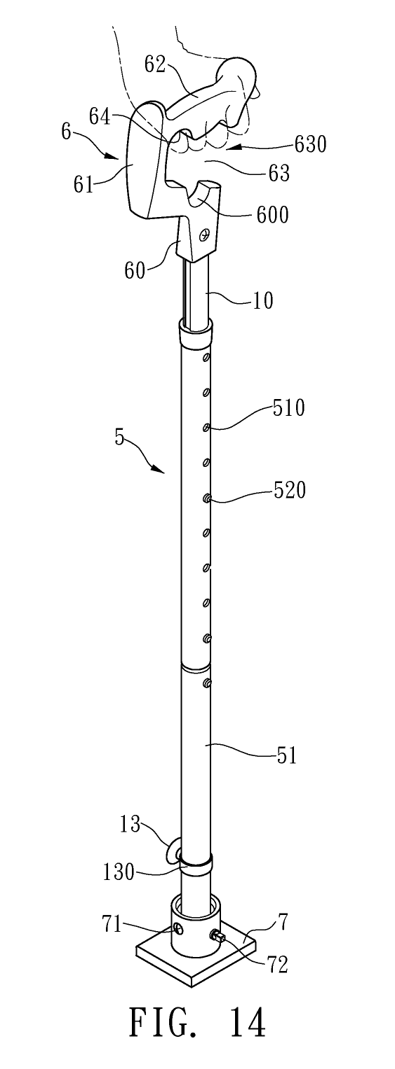

When the disclosed doorstop bar blocks on the inner side of the door, one moves the mount opening 630 of the stopping element 6 toward the doorknob. The doorknob 3 is thus in the space 63. The user then pushes front fork part 60 upward so that the neck part 30 of the doorknob 3 embeds in the holding part 600. The inner bar 50 of the retractable bar 5 is adjusted to an appropriate length according to the distance between the doorknob 3 and the ground. In this case, the urging element 7 urges against the ground because of an angle with respect to the outer bar 51. The doorstop bar thus firmly blocks behind the door, as shown in FIG. 9. When the disclosed doorstop bar is used for blocking, the stopping element 6 does not only embeds into the neck part 30 of the doorknob 3 via the holding part 600 of the front fork part 60, but also touch tightly against the door with the side of the stopping part 62. This achieves double urging and provides a firm support. When the disclosed doorstop bar is not in use, as shown in FIG. 13, it can be hung on the neck part 30 of the doorknob 3 using the recess part 64 of the stopping element 6. The doorstop bar can thus be firmly hung on the back of the door, and does not occupy indoors space or space in a storage room. The outer bar 51 has two sections connected together. One can separate the two sections of the outer bar 51 when traveling. This shortens the length of the outer bar for the convenience of carrying.

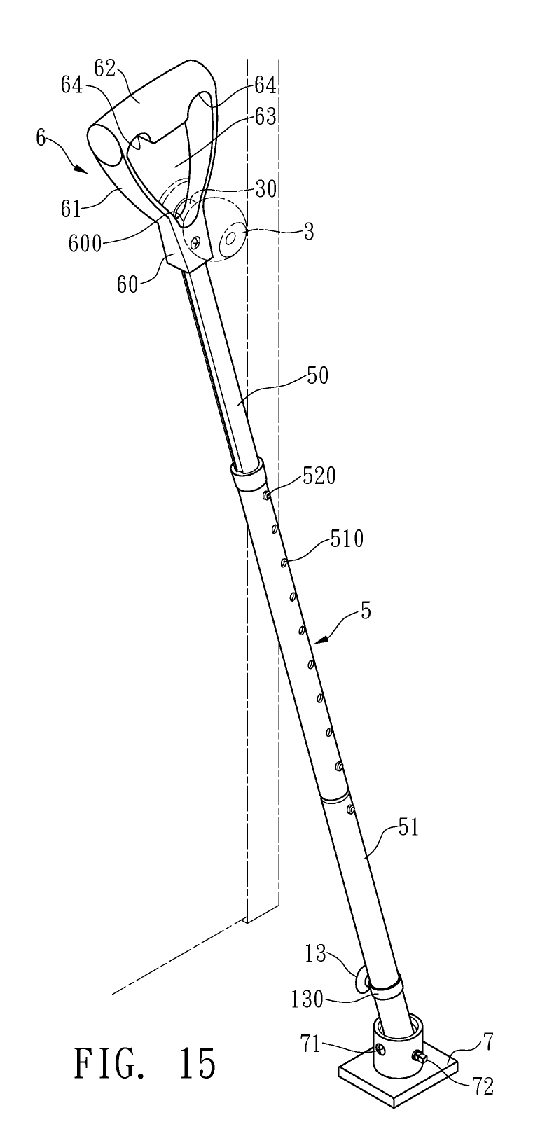

As shown in FIG. 14, when the doorstop bar is used as a walking stick, the user can adjust the urging element to be perpendicular to the outer bar 51. That is, the urging element 7 flatly touches the ground when the outer bar 51 stands vertically. The user can hold the stopping part 62 and uses the doorstop as an extra support while walking.

According to the above description, the disclosed doorstop bar can function as a block behind the door for anti-theft effect and a walking stick as well. For example, it helps a senior person or a person whose feet are hurt to walk. Moreover, it can provide an extra support when the user is hiking or walking. Therefore, the doorstop bar has additional utilities. Besides, the design of two sections for the outer bar 51 enables the doorstop bar to be shortened for the convenience of carriage and storage.

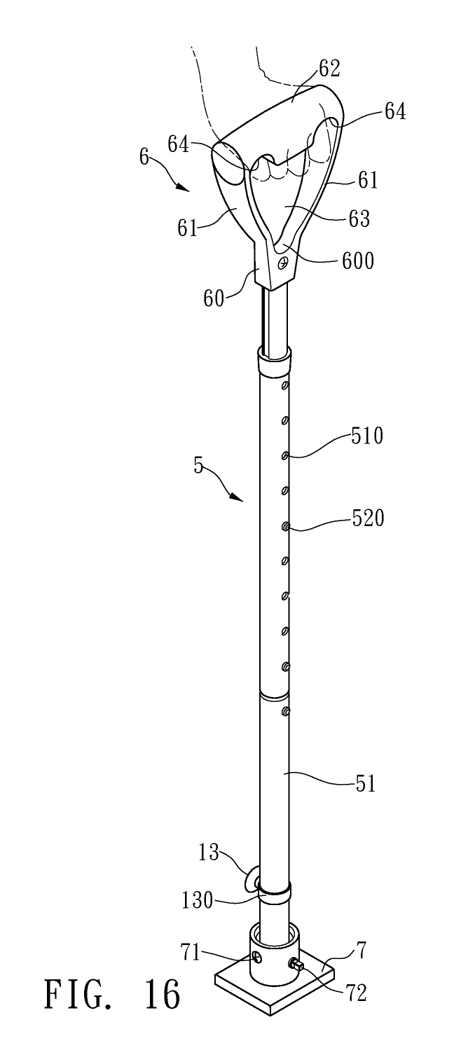

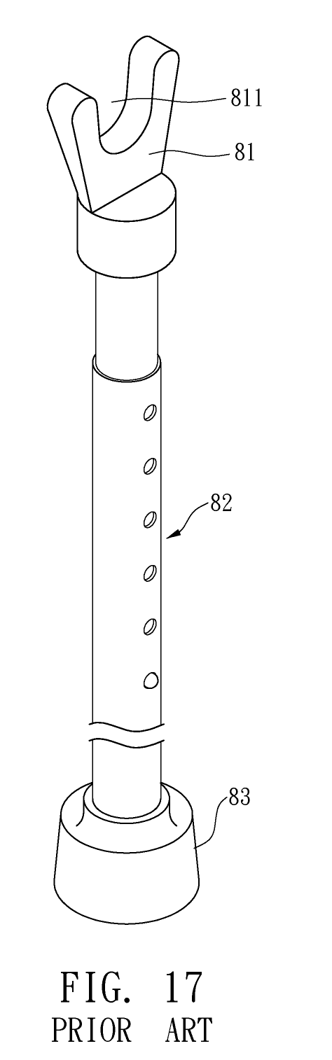

Please refer to FIGS. 15 and 16 for a fourth embodiment of the invention. This embodiment is an improvement over the third embodiment. Opposite sides of the holding part 600 at the top of the front fork part 60 are extended with an extension part 61, respectively. The space 63 is surrounded by the top end of the front fork part 60, the stopping part 62, and the two extension parts 61, forming another doorstop bar configuration. When the doorstop bar of this embodiment blocks behind the door, the stopping element 6 mounts the doorknob 3 into the space 63. The holding part 600 on the front end of the front fork part 60 urges against the neck part 30 of embedded doorknob 3. The stopping element 62 blocks behind the door, as shown in FIG. 15. The user can hold the stopping part 62 as well. When storing the doorstop bar in this embodiment, the user also uses the recess part 64 in the stopping element 6 to hang on the neck part 30 of the doorknob 3 (not shown in another plot). As shown in FIG. 16, the doorstop bar can also function as a walking stick, achieving the same effect as the third embodiment.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. A doorstop bar, comprising:
a retractable bar including an inner bar inserted into an outer bar from one end, wherein the inner can extends out of or retracts into the outer bar, and a positioning element is provided between the inner bar and the outer bar for positioning the inner bar after retraction;
a stopping element provided at the top of the retractable bar, wherein the stopping element has a holding part and a hooking element; and
an urging element provided at the bottom of the retractable bar for urging against the ground.

2. The doorstop bar of claim 1, wherein the hooking element is a hook vertically extended upward from one side of the holding part of the stopping element and bent to form a hooking part, and the downward bottom of the hooking part and the other side of the stopping element form a mount opening.

3. The doorstop bar of claim 1, wherein the hooking element is a rope loop.

4. The doorstop bar of claim 1, wherein the positioning element is a bent elastic chip disposed in the inner bar, a protruding button that automatically bounces back after being depressed exposes from one side of the inner bar, the outer bar has a plurality of positioning holes along the retracting direction of the inner bar, and each of the positioning holes enables the protruding button to protrude and stop when the inner bar retracts.

5. The doorstop bar of claim 1, wherein the back side of the urging element has an embedding recess with a sucking element corresponding to a door.

6. The doorstop bar of claim 5, wherein the sucking element includes a second embedding part and a magnet, the magnet is provided on one side of the second embedding part, and the other side of the second embedding part is embedded in the embedding recess.

7. The doorstop bar of claim 5, wherein the sucking element includes a second embedding part and a sucker, the sucker is provided on one side of the second embedding part, and the other side of the second embedding part is embedded in the embedding recess.

8. A doorstop bar also functioning as a walking stick, comprising:
a retractable bar including an inner bar inserted into an outer bar from one end, wherein the inner bar can extend out of or retract into the outer bar, and a positioning element is provided between the inner bar and the outer bar for positioning the inner bar after retraction;
a stopping element having a front fork part extended from the exposed end of the inner bar, wherein the front fork part has a holding part, the top of the front fork part extends at least one extension from the side of the holding part, each of the extension parts is bent as a stopping part for holding when used as a walking stick, the extension direction of the stopping part is roughly perpendicular to the retractable bar, a space is formed among the stopping part, the extension parts, and the front fork part for the insertion of a neck part of doorknob, the holding part is for the neck part to embed, the extension parts and the stopping part form a recess part in the space for hooking onto the neck part at the bending portion; and
an urging element provided at the bottom of the outer bar for urging against the ground.

9. The doorstop bar of claim 8, wherein the urging element is pivotally mounted at the bottom of the outer bar and fixes after the angle between the outer bar and the ground is adjusted; the urging element has a cavity for the insertion of one end of the outer bar, the width of the cavity being larger than the diameter of the outer bar; a pivotal axis goes through the urging element and the outer bar so that the outer bar is capable of swing sideways in the cavity; a limiting screw locks the urging element from the side into the cavity, the locking depth being adjusted by the limiting screw; the limiting screw urges against the outer bar to restrict the outer bar when the outer bar stands vertically to function as a walking stick.

10. The doorstop bar of claim 9, wherein the positioning element is a bent elastic chip disposed in the inner bar; a protruding button that bounces back after being depressed exposes on one side of the inner bar, the outer bar has a plurality of positioning hole along the retracting direction of the inner bar in a line; and each of the positioning holes allows the protruding button to protrude and stop when the inner bar retracts.

11. The doorstop bar of claim 9, wherein the top of the front fork part extends an extension part from the side of the holding part, and the other side of the space toward the extension part has a mount opening.

12. The doorstop bar of claim 11, wherein the width on the end of the front fork part near the space is shrunk inward, and the doorknob is not blocked by the front fork part sideways so that the neck part is moved into the space via the mount opening.

13. The doorstop bar of claim 9, wherein the top of the front fork part is extended with an extension part from opposite two ends of the holding part, respectively, and the space is surrounded by the top of the front fork part, the stopping part, and the two extension parts.

14. The doorstop bar of claim 9, wherein the outer bar has at least two sections.

15. The doorstop bar of claim 9 further comprising a sucker to suck onto a door, wherein the sucker has a mounting ring on the side thereof, the mounting ring is mounted on the outer bar so that the sucker is close to the end of the urging element, and the position of the sucker is moved to adjust the position thereof on the outer bar.
